(19) United States
(12) Patent Application Publication
(10) Pub. No.: US 2011/0303806 A1
(43) Pub. Date: Dec. 15, 2011

(54) MOBILE FIGURE STAND

(76) Inventors: Gregory Samaras, Woodside, NY (US); Edward J. Boll, Stuyvesant, NY (US)

(21) Appl. No.: 13/049,414

(22) Filed: Mar. 16, 2011

Related U.S. Application Data
(60) Provisional application No. 61/354,796, filed on Jun. 15, 2010.

(51) Int. Cl. F16M 11/20

(52) U.S. Cl. 248/156

(57) ABSTRACT

A decoy display stand powered by air flow or wind force is provided including a vertical stake and a horizontal frame. The frame includes vertical support rods and a horizontal bar having a central horizontal frame and two horizontal extension frames. The vertical support rods are disposed at the outer ends of the horizontal extension frames and receive figures such as animal decoys or seasonal ornaments. The stake is received by the central horizontal frame and permits 360 degree rotation of the central horizontal frame around the stake with wind or manual energy. The figures are designed to capture energy and facilitate the rotation of the frame about the stake. A fastener is provided adjacent the central horizontal frame and the stake to manage rotation of the frame in varying degrees between free rotation and no rotation and, in some cases, adjust the height of the frame from the ground.

### PRIORITY AND RELATED APPLICATION

This application claims priority to U.S. Provisional Patent Application Ser. No. 61/354,796, filed Jun. 15, 2010, entitled DECOY DISPLAY, which is hereby incorporated by reference in its entirety.

### FIELD OF THE INVENTION

The present invention relates to stands for holding ornamental figures or decoys, particularly to portable stands that both support and permit movement of ornamental figures or decoys by wind, energy or air force.

### BACKGROUND OF THE INVENTION

Outdoor support stands for decoys or lawn ornaments exists, however none provide the ability to freely rotate in at least two points in response to environmental cues such as wind, energy or air force. This is especially true with hunting decoys displays. One hunting decoy display stand that is deficient is U.S. Pat. No. 7,788,840 to Wyant, et al. The '840 patent provides an apparatus for revolving decoys about a vertical axis using a motor and a complex support structure. Rotation is controlled by the motor and is not affected by wind energy or air force. Accordingly a display stand is desired that is portable, simple and permits rotation of decoys or figures using wind energy or wind force.

### BRIEF SUMMARY OF THE INVENTION

A mobile figure stand includes a horizontal frame and a vertical stake where the frame moves in response to environmental cues such as air force, varying strengths of wind energy or manual force. In one embodiment, the stake may include an outer and inner post. The outer and inner posts are coupled by mechanisms such as a pin-hole or a friction-fit mechanism. In one embodiment, the stake may facilitate vertical adjustment of the stand and thus the horizontal frame at any distance from the ground. A bottom end of the vertical stake may be inserted into the ground or into a base. The top end of the vertical stake is inserted through a central port of the horizontal frame. A fastener or tension adjuster is placed at the junction by the vertical stake and the central horizontal frame and is used to manage the rotational speed of the horizontal frame and may be used to facilitate vertical adjustment of the horizontal frame from the ground. When tension is applied to the central horizontal frame by the tension adjuster fastener, the rotational speed of the central horizontal frame slows down and when less or no tension is applied the central horizontal frame is permitted to freely rotate about 360 degrees clockwise or counterclockwise or in a random rotational manner.

The horizontal frame further includes two horizontal extension frames and two vertical support rods. The inner ends of the horizontal extension frames are connected to the central horizontal frame and the outer ends of the horizontal extension frames are connected to vertical support rods. The vertical support rods hold figures such as animal decoys or seasonal figurines which are designed to capture wind energy or wind force. The wind force propels the figures to rotate about the vertical support rods and also permits circular rotation of the frame about the stake of the stand. In addition to this movement pattern the winds velocity and direction often varies allowing each of the decoy figures to compensate for the others movement. This check and balance system discourages a merry-go-round effect and instead creates a sporadic and unpredictable movement pattern. As the decoys/figures rotate and roam on their individual axis each establish an individual character. The decoys will sometimes come to a complete stop and remain stationary only to change direction and once again continue their irregular maneuvering and alternate direction while traveling about the stake. This unpatterned, irregular maneuvering creates a non-repetitious sequence and life-like display.

### BRIEF DESCRIPTION OF THE DRAWING

FIG. 1A shows one embodiment of a mobile figure stand of the present invention shown in an open position with figures shown in dotted lines.

FIG. 1B shows an alternative embodiment of a mobile figure stand of the present invention shown in an open position.

FIG. 1C shows the mobile figure stand of FIG. 1B in a closed position.

FIG. 2 shows the stand of FIG. 1A without the figures.

FIG. 3A is view an exploded view of the stand of FIG. 1A.

FIG. 3B is an exploded view of a fastener used in FIG. 3A.

FIG. 3C is an assembled view of the fastener in FIG. 3B disposed by the central horizontal rod 310 and inner stake.

### DETAILED DESCRIPTION OF THE INVENTION

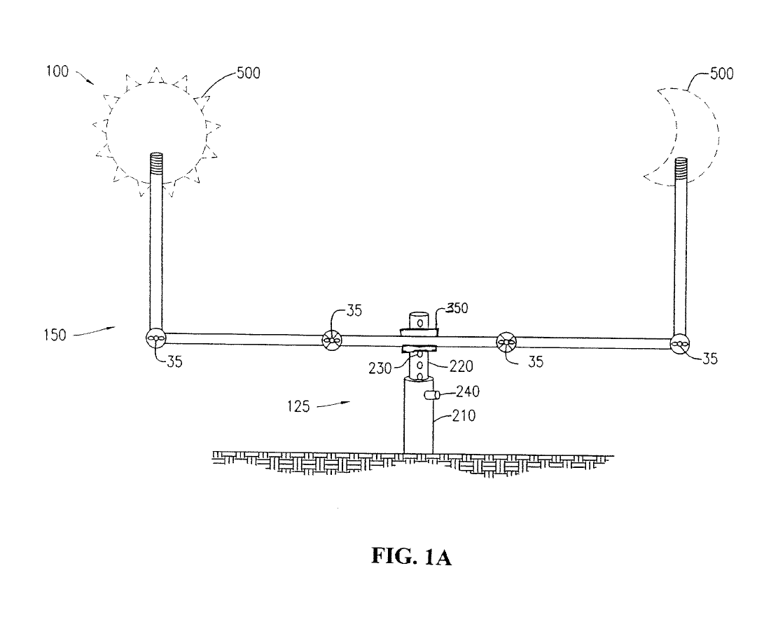

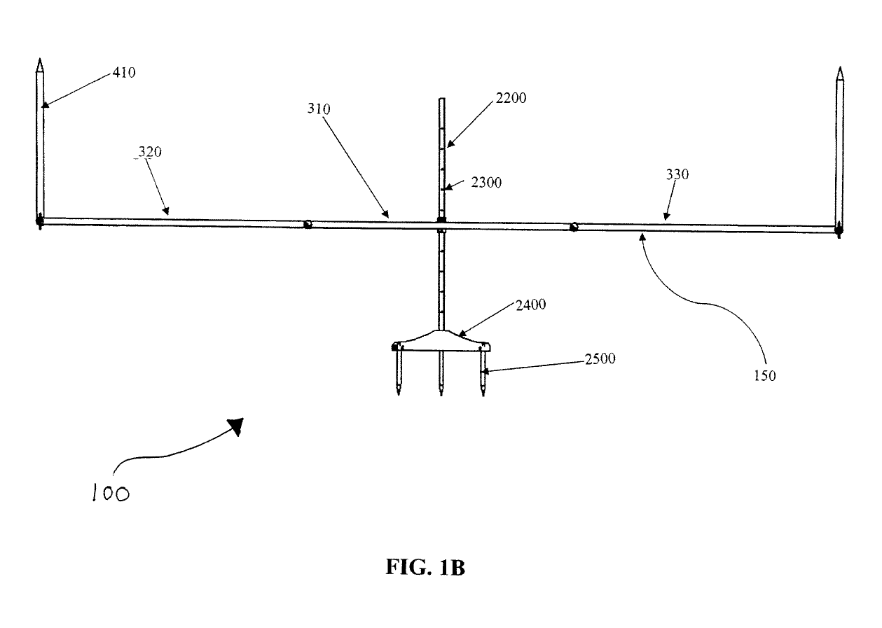

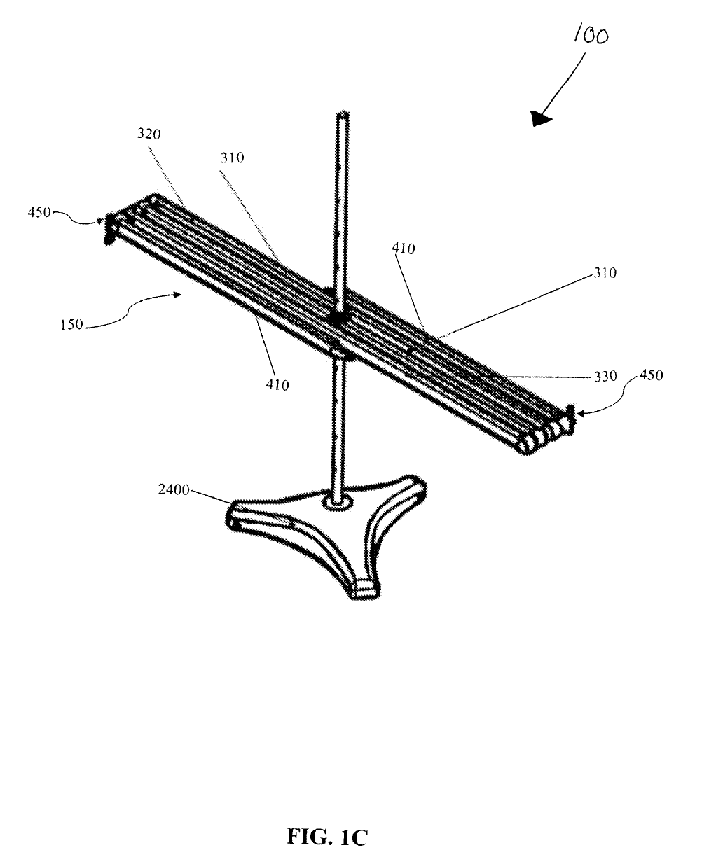

FIG. 1A shows a mobile figure stand 100. The stand 100 includes a vertical stake 125 and a horizontal frame 150. The stake 125 has a top end that inserts into the frame 150 and a bottom end for inserting into the ground or other surface. The vertical stake 125 includes a height adjusting mechanism that permits the frame 150 to be adjusted to any distance from the ground or support surface. In one embodiment, the stake 125 includes an outer post 210 coupled to an inner post 220. The outer and inner posts 210, 220 are part of the height adjusting mechanism wherein the outer and inner posts 210, 220 are coupled together to permit the raising and lowering of the frame 150 that is attached to the stake 125. The outer and inner posts 210, 220 may be coupled together using any number of mechanisms such as by friction fit, hole 230 and pin 240, screw groves, clamps, pneumatic systems, etc. In one preferred embodiment any simple height adjusting mechanism is used.

FIG. 1B shows another embodiment of stand 100 where the stake 125 is a single post 2200 with perforations 2300 similar to inner post 220 with holes 230. Here, the perforations 2300 of the single post 2200 in conjunction with the frame 150 are employed as the height adjusting mechanism. In another embodiment, a base 2400 may be used that is securable to the ground using pins 2500, stakes or any other means that secure the base 2400 to the ground with the bottom end of the single post 2200 being removably insertable into the base 2400.

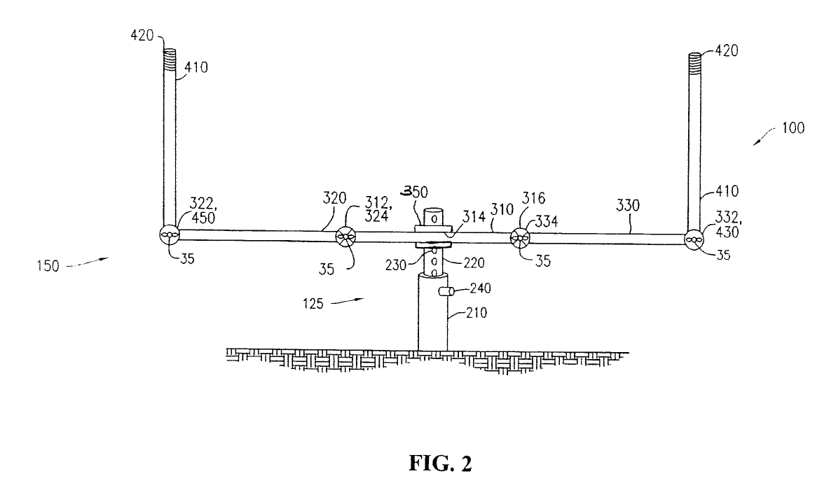

Referring now to FIGS. 1A, 1B, and 2, the horizontal frame 150 is shown to include a horizontal bar 310, 320, 330 and vertical support rods 410. The horizontal bar comprises a central horizontal frame 310 flanked by a first horizontal extension frame 320 and a second horizontal extension frame 330. The central horizontal frame 310 has a first end 312 and a second end 316 and a central port 314 disposed equidistant from the first and second ends 312, 316. The first horizontal extension frame 320 and the second horizontal extension frame 330 each has an inner end 324, 334 and an outer end 322, 332, respectively. The inner end 324 of the first horizontal extension frame 320 is connected to the first end 312 of the central horizontal frame 310 and the inner end 334 of the second horizontal extension frame 330 is connected to the second end 314 of the central horizontal frame 310. At each outer end 322, 332 of the first and second horizontal extension frames, 320, 330, respectively, is disposed at least one vertical support rod 410. The vertical support rod 410 has a receiving end 420 and a securing end 430. It is the securing end 430 that is connected to each outer end 322, 332 of the first and second horizontal extension frames, 320, 330, respectively. The receiving end 420 is used to accept figures 500 and figurines including and not limited to decoys, ornaments and the like. In one embodiment, the receiving end 420 of the vertical support rod 410 may be grooved, as shown in FIGS. 1A and 2, or pointed as shown in FIG. 1B, for accepting the figures 500.

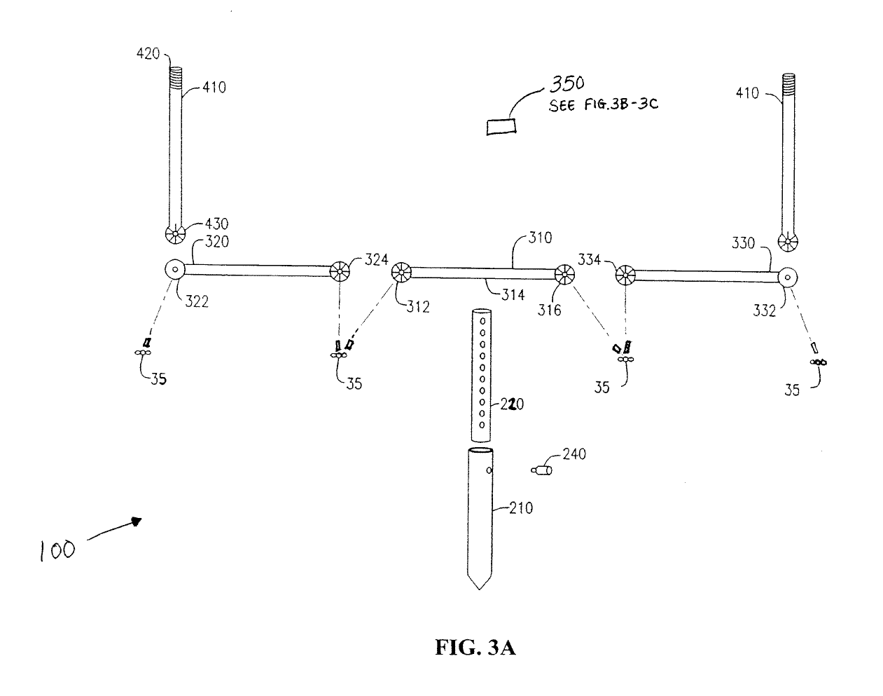

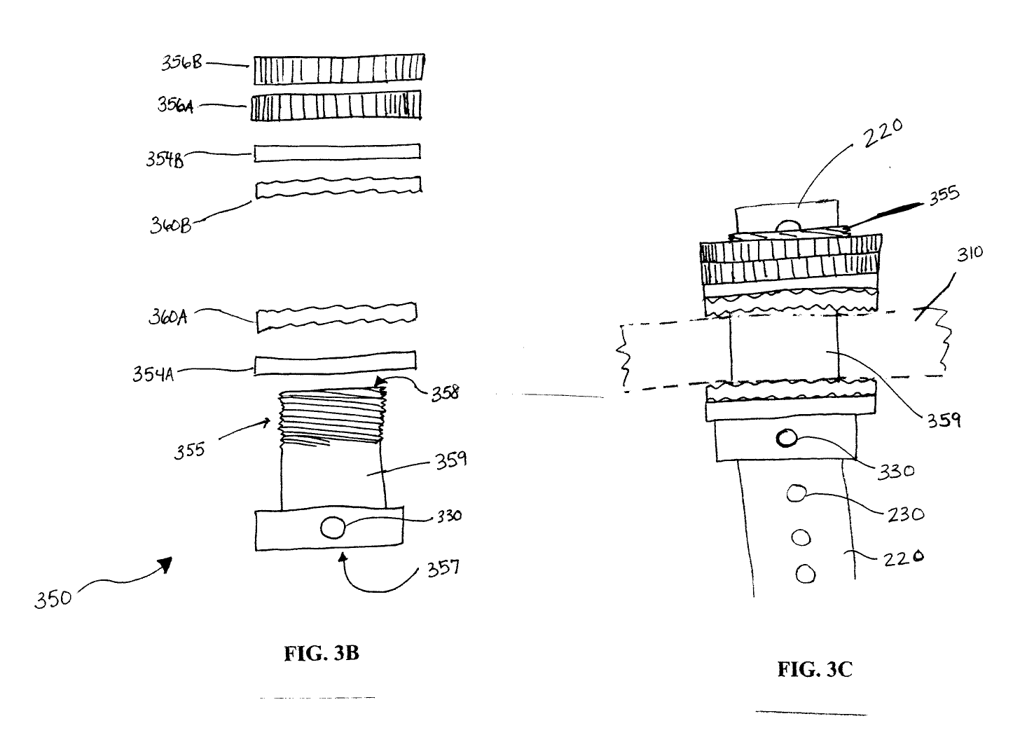

Referring now to FIG. 2, each of the first and second ends 312, 316, of the central horizontal frame 310 connects to the inner ends 324, 334 of the first and second horizontal extension frames 320, 330, while the outer ends 322, 332 of the first and second horizontal extension frames 320, 330, respectively connect to the receiving ends 430 of the vertical support rod 410. In one embodiment, the ends 312, 316, 324, 334, 322, 332 and 430 may include teeth and grooves that mate with the corresponding part, see FIGS. 2 and 3A. By employing the teeth and grooves at each end 312, 316, 324, 334, 322, 332 and 430 the frame 150 is able to maintain its configuration without compromise from any elements such as weather, human or animal interference. In an alternative embodiment, the ends may forgo the use of teeth and grooves. A fastener 35 may be used to secure each of the joining ends 312, 316, 324, 334, 322, 332 and 430. One example of fastener 35 includes a wing nut and washer, see FIG. 3A. One embodiment of the fastener 35 is shown in FIGS. 3B and 3C as fastener 350.

The portable mobile figure stand 100 may be designed to be easily or readily assembled and disassembled. In one embodiment, each the inner ends 324, 334 of the first and second horizontal extension frames, 320, 330, respectively, may be removably connected or otherwise connected to the first 312 and second 316 ends of the central horizontal frame 310, respectively as shown in FIG. 3A. In another embodiment, shown in FIG. 1C, the vertical supporting rods 410 may fold at end 450 and lie adjacent each first and second horizontal extension frames 320, 330, and each first and second horizontal extension frames, 320, 330 may in turn fold at each inner end 324, 334 and lie adjacent the central horizontal frame 310 for purposes of readily packing and transporting the entire frame 150. The ends 312, 316, 324, 334, 322, 332 and 430 in the embodiment shown in FIG. 1C may not use teeth and groove and may be smooth employing wing nuts and/or rivets to permit easy opening and closing of the entire frame 150.

As mentioned above, the stake 125 inserts into the frame 150, specifically at the central port 314 of the central horizontal frame 310. In one embodiment, the fastener 350 is used at the junction by the stake 125 and central horizontal frame 310. The fastener 350 may be a screw or a clamp or other device used to manage the tension between the central horizontal frame 310 and the stake 125. In another embodiment the fastener 350 may be defined as a housing tube, see FIGS. 3B-C. The housing tube fastener 350 has a circular receiving end 357, a shaft 359 and a threaded portion 355 adjacent the top end 358. The circular receiving end 357 is configured to receive the stake 125 and permit the stake 125 to pass through the top end 358 of the housing tube fastener 350. When positioned for use with the stake 125 and the central horizontal bar 310, the housing tube fastener 350 is slid over the top end of the stake 125 then both the stake 125 and housing tube fastener 350 is slid up through the central port 314 of the central horizontal bar 310 with the receiving end 357 lying just under the central horizontal bar 310. The central horizontal bar 310 will therein conceal the shaft 359 of the housing tube fastener 350. A spring loaded pin 240 may be used in the receiving hole 330 of fastener 350 to position the fastener 350 at any location along the stake 125. Once the fastener 350 is in place a washer 354A and friction disc 360A is placed on the fastener 350 followed by the central horizontal bar 310 then washer 354B, friction disc 360B, and finger tightening nuts 356A and 356B.

The fastener 350 may serve two functions. First, the fastener 350 will control the height at which the horizontal bar 310, 320, 330 is stationed above the ground level. Second, the fastener 350 will act as a tension adjuster to control the speed at which the horizontal frame 310, 320, 330 revolves around the stake 125. In one embodiment, the fastener 350 will serve both functions. In other embodiments the fastener 350 will be used to serve one of the two above-described functions. When used to control the height of the horizontal bar 310, 320, 330 from the ground level, the pin 240 is placed into opening 330 of the fastener 350 and then locked into the opening 230 of the stake 125.

When the fastener 350 is used to control the rotation speed of the horizontal bar 310, 320, 330, the fastener 350 is selectively tightened or loosened in relation to the horizontal bar 310, 320, 330 using nuts 356A,B, washers 354A, B and friction discs 360 A,B. For instance, in a first position, the housing tube fastener 350 is loose and permits a free 360 degree rotation of the horizontal bar 310, 320, 330, while in a second position the fastener 350 is tight and does not permit rotation of the horizontal bar 310, 320, 330. A series of intermediate positions exist between the first and second position where the horizontal bar 310, 320, 330 is rotatable about the stake 125 in varying degrees between free rotation and no rotation. To create this tension using the housing tube fastener 350, the nuts 356A, B are tightened or loosened so the friction discs 360 A,B apply pressure at the point where the discs 360A and 360B meets the central horizontal frame 310. In one embodiment, the discs 360 A, B are made of rubber or felt or other material that creates friction. Thus, when the nuts 356A, B are tightened the discs 360 A,B create resistance preventing the horizontal bar 310, 320, 330 from readily moving in response to wind energy and decreases the speed at which the horizontal frame 310, 330 revolves and vice versa. The amount of pressure applied can be adjusted to an almost infinite position of calibration.

The stand 100 may be made to have any dimensions. For instance, the central horizontal frame 310 and the horizontal extension frames, 320, 330 may be 20 inches long. When assembled, the central horizontal frame and two horizontal extension frames may span 60 inches and when disassembled the frame 150 may be 20 inches permitting compact packing for easy transport. The vertical support rods 410 may be 12″ long or any length sufficient to hold figures 500 while also being shorter than the length of the horizontal extension frames 320, 330. The stake 125 may be between 15-25 inches long or other dimension similar to the parts of the frame 150 and thus be readily packed with the frame 150. The materials used to make the frame 150 may be any durable material that can stand up to weather elements and is rust proof and also have some weight but not be too heavy to prevent easy transport. The stake 125 may also be durable and withstand elements from the weather and be rust proof and the bottom end of the stake 125 may further be designed to readily pierce the ground or other surface or be positioned into a base.

The figures 500 employed with the stand 100 may be of any design. For instance, the figures may be lawn ornaments such as weather related figures such as the sun and the moon, seasonal or holiday figures such as a witch and a moon, two ghosts, a cat and a mouse, etc. In another embodiment the figures 500 may be pest control figures 500 or hunting decoys including animal decoys such as coyotes. Regardless of what figures 500 is used, all figures will be designed to capture wind energy and permit the horizontal bar 310, 320, 330 to rotate 360 degrees about the stake 125 creating an unpredictable and uncontrollable sporadic pattern and being able to reverse directions when both revolving and rotating. The use of the figures. 500 with the frame 150 facilitates the rotation motion of the frame 150 about the stake 125 without the need for motors, electrical devices or advanced technology. The figures 500 may further rotate at the vertical support rods 410 as the figures 500 may be mounted on the vertical support rod 410 by any conventional means such as friction-fit, clamping, screws or the like that make possible individual rotation about the vertical support rod 410.

The stand 100 may use one figure on the frame 150 or multiple figures 500 being either the same figure or different figures on each vertical supporting rod 410. When multiple figures 500 are used and when the frame 150 is set in motion, the figures 500 may be depicted as chasing after each other. When animal decoys are used such as turkeys, coyotes, etc. and the frame 150 is in motion, the turkeys, coyotes, etc. appear life-like able to catch the eye and attention of a particular audience. The figures 500 may be designed to catch the slightest wind force or other force and rotate about either the vertical support 410 or about the stake 125 in sporadic maneuvers to mock lifelike actions and thus resemble natural behaviors creating a presentation that appears realistic and authentic. The tension adjuster fastener 350 at the junction by the stake 125 and central horizontal frame 310 may be used to control the rotational speed of the figures 500 about the stake 125. Another tension adjuster fastener (not shown) may also be used by the receiving end 420 of the vertical support rod 410 to control the rotation of the figures 500 about the vertical support rod 410. If no wind or other energy force is present the frame 150 and figures 500 may be stationary or slightly wavering until such energy force is present.

An advantage of the present stand 100 is that it does not use a motor or any electrical devices to propel the frame 150 or rotate the figure about the vertical support rod 410 and is only driven by wind, manual rotation or other environmental forces. The benefit of a motor-free stand 100 is especially apparent when hunting in a fair-chase environment such as in New York State and the majority of other states where hunts may only be conducted without the use of motorized devices or advanced technology.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A stand comprising:
a stake;
a central horizontal frame having a first end and a second end and a port disposed centrally between the first and second ends, said central port receiving a top end of said stake, said stake passing through the central port, said central horizontal frame rotating about said stake in response to wind energy;
a first horizontal extension frame having an outer end and an inner end, said inner end of said first horizontal extension frame being removably securable to the first end of the central horizontal frame;
a first vertical support rod having a receiving end and a securing end, said securing end being removably securable to said outer end of said first horizontal extension frame;
a second horizontal extension frame having an outer end and an inner end, said inner end of said second horizontal extension frame being removably securable to the second end of the central horizontal frame; and
a second vertical support rod having a receiving end and a securing end, said securing end being removably securable to said outer end of said second horizontal extension frame.

2. The stand of claim 1, wherein a first ornament is disposable on said receiving end of said first vertical support rod and a second ornament is disposable on said receiving end of said second vertical support rod, wherein said first ornament and said second ornament is designed to capture wind energy, said first ornament and said second ornament being propelled in said circular motions about said first and second vertical support rods, respectively, by wind energy.

3. The stand of claim 2, wherein when said first ornament and said second ornament move in response to the wind energy, said central horizontal frame, said first horizontal extension frame and said second horizontal extension frame move in circular motions about said stake without using a motor.

4. The stand of claim 2, wherein said first ornament and said second ornament is an animal decoy.

5. The stand of claim 2, wherein said first ornament and said second ornament is a seasonal figurine.

6. The stand of claim 1, further comprising a tension adjuster securable to said top end of said stake adjacent said central horizontal frame, said tension adjuster having a first position, a second position, and a series of intermediate positions between said first and said second positions, wherein in said first position said central horizontal frame is freely rotatable about said stake in 360 degrees, in said second position said central horizontal frame is restricted from rotating about said stake, and in said series of intermediate positions said central horizontal frame is rotatable about said stake in varying degrees between free rotation and no rotation.

7. The stand of claim 1, wherein said stake employs said central horizontal frame in defining a height adjustment mechanism, said stake being disposed on a base for securing to a ground surface.

8. A stand comprising:
a stake, said stake including a height adjustment mechanism; and
a frame including,
a central horizontal frame having a first end and a second end and a port disposed centrally between the first and second ends, said central port receiving a top end of said stake, said central horizontal frame capable of rotating about said stake,
a first horizontal extension frame having an outer end and an inner end, said inner end of said first horizontal extension frame being securable to the first end of the central horizontal frame,
a second horizontal extension frame having an outer end and an inner end, said inner end of said second horizontal extension frame being securable to the second end of the central horizontal frame,
a first vertical support rod having a receiving end and a securing end, said securing end being securable to said outer end of said first horizontal extension frame, and
a second vertical support rod having a receiving end and a securing end, said securing end being securable to said outer end of said second horizontal extension frame.

9. The stand of claim 8, wherein a first ornament is disposable on said receiving end of said first vertical support rod and a second ornament is disposable on said receiving end of said second vertical support rod, each said first ornament and said second ornament being designed to capture wind energy, said first ornament and said second ornament being propelled in said circular motions about said first vertical support rod and said second vertical support rod, respectively, by wind energy.

10. The stand of claim 9, wherein said first ornament and said second ornament moves in said circular motions about said stake in response to wind energy.

11. The stand of claim 9, wherein said first ornament and said second ornament is an animal decoy.

12. The stand of claim 9, wherein said first ornament and said second ornament is a seasonal figurine.

13. The stand of claim 8, wherein said height adjustment mechanism permit positioning of the frame at various heights along said stake.

14. The stand of claim 8, wherein said height adjustment mechanism includes an inner post and an outer post, said inner post being adjustably coupled to said outer post, said outer post being insertable in a support surface.

15. The stand of claim 14, wherein said inner post and said outer post are adjustably coupled using a pin and hole system, a friction-fit system, a clamp system and a pneumatic system.

16. A stand comprising:
a vertical stake; and
a horizontal frame including,
a central horizontal frame having a first end and a second end and a port disposed centrally between the first and second ends, said central port capable of receiving a top end of said vertical stake, said central horizontal frame capable of rotating about said vertical stake,
a first horizontal extension frame having an outer end and an inner end, said inner end of said first horizontal extension frame being securable to the first end of the central horizontal frame,
a first vertical support rod having a receiving end and a securing end, said securing end being securable to said outer end of said first horizontal extension frame,
a second horizontal extension frame having an outer end and an inner end, said inner end of said second horizontal extension frame being securable to the second end of the central horizontal frame, and
a second vertical support rod having a receiving end and a securing end, said securing end being securable to said outer end of said second side rod; and
a tension adjuster securable to the top end of the vertical stake, said tension adjuster having a first position, a series of intermediate positions and a second position, wherein in said first position said central horizontal frame is freely rotatable about said vertical stake in 360 degrees, in said second position said central horizontal frame is restricted from rotating about said vertical stake, and in said series of intermediate positions said central horizontal frame is rotatable about said vertical stake in varying degrees between free rotation and no rotation,
wherein said tension adjuster serves as a height adjustment mechanism being adjustably coupled to said central horizontal frame to permit positioning of the central horizontal frame at various heights along said vertical stake.

17. The stand of claim 16, wherein the height adjustment mechanism includes a pin and hole system, a friction-fit system, a clamp system and a pneumatic system.

18. The stand of claim 17, wherein a first ornament on a first vertical support rod and a second ornament on a second vertical support rod are each designed to capture air flow, said first ornament and said second ornament capable of being propelled in said circular motions about said first and second vertical support rods, respectively, by air flow, and wherein said first ornament and said second ornament move in unpredictable sporadic patterns when revolving and rotating.

19. The stand of claim 18, wherein frame moves in circular motions about said vertical stake in response to movement by said first ornament and said second ornament.

20. The stand of claim 16, wherein said frame is readily adjustable between an open position where each said central horizontal frame, said first horizontal extension frame, and said second horizontal extension frame, said first vertical support rod and said second vertical support rod are extended and a closed position where each said central horizontal frame, said first horizontal extension frame, and said second horizontal extension frame, said first vertical support rod and said second vertical support rod are folded lying adjacent each other.
